(19) United States
(12) Patent Application Publication
(10) Pub. No.: US 2026/0368809 A1
(43) Pub. Date: Nov. 19, 2026

(54) Multilateral Trading Platform for Near Real-time Optimization using Template Trades

(71) Applicant: TRIOPTIMA AB, Stockholm (SE)

(72) Inventors: Vikash Rughani, Jersey City, NJ (US); Oliver Favell, London (GB); Carl Thornberg, Stockholm (SE); Ariyan Abdulla, Stockholm (SE); Karl Wallström, Enköping (SE)

(21) Appl. No.: 19/130,191

(22) PCT Filed: Nov. 15, 2023
(86) PCT No.: PCT/US2023/079850

§ 371 Date: May 15, 2025

Related U.S. Application Data
(60) Provisional application No. 63/383,758, filed on Nov. 15, 2022.

(51) Int. Cl. G06Q 40/04

(52) U.S. Cl. CPC G06Q 40/04

(57) ABSTRACT

Systems and methods are disclosed that transforms data objects using a multilateral netting arrangement/optimization. The data objects may represent risk from non-standard granular points to standard points. The multilateral netting arrangement/optimization may analyze and process the order books/systems of more than two parties/traders/users to determine matches, while maintaining exposures as measured on standard risk points. The operations may occur in real-time (and/or near real-time) generation and execution through a coordinated, nearly-simultaneous execution of the order transactions that the system generates for the multiple parties (e.g., multilateral) involved in multiple levels/degrees of deep optimization.

### CROSS-REFERENCE TO RELATED APPLICATIONS

This application claims the benefit of, and priority to, U.S. Provisional Patent Application No. 63/383,758 filed on Nov. 15, 2022, the content of which is expressly incorporated herein by reference in its entirety for any and all non-limiting purposes.

### TECHNICAL FIELD

In prior art financial instrument trading systems, some tenors are standard (e.g., 5-year, 10-year, 20-year, and so on) and other tenors are non-standard (e.g., 17-year, 19-year, etc.). The term tenor sometimes refers to the length of time remaining before expiration of a financial instrument, but it is sometimes also used interchangeably with the maturity, although the two terms can have distinct meanings. Tenor may also be based on the start of an instrument, or in some examples, the middle. In some embodiments, the system may create trades starting and ending at different tenors, so tenors may in those examples be a point in time that is often traded, specifically a point in time on a yield curve that is often traded. Trading systems that manage market risk are typically unable to efficiently mitigate, in near real-time, market risk on non-standard tenors, due to the illiquidity of trading at those tenors. The market risk on non-standard tenors arises from trading with non-financial institutions or from time-effects, e.g., the 20-year tenor becomes the 19-year tenor when one year has passed.

For example, parties/users/traders of forward contracts/instruments are exposed to a greater degree of settlement and default risk compared to instruments that are regularly marked-to-market. Forward contracts are sometimes used to hedge currency and/or interest rate risks. But since the details of forward contracts are restricted to the counterparties involved, it is difficult for non-parties to size the market and illiquidity risk. Although a futures contract trades on an exchange, a forward contract typically does not. The non-standard characteristic of forward contracts means they are only settled on the settlement date and are not regularly marked-to-market like futures. Thus, if the forward rate specified in the contract diverges widely from the spot rate at the time of settlement, then the party/user/trader that originated the forward contract is exposed to a greater degree of risk in the event of non-settlement/default by the party/user/trader than if the contract/instrument were regularly marked-to-market.

### SUMMARY

This summary is provided to introduce a selection of features in a simplified form that are further described below in the detailed description. The summary is not intended to identify key features or essential features of the claimed subject matter, nor is it intended to be used to limit the scope of the claimed subject matter. Moreover, one or more of the steps and/or components described above may be optional or may be combined with other steps. In addition, although several illustrative embodiments disclosed herein related to a service for the interest rate derivative market and use forward-starting swaps, the disclosure is not so limited. The disclosure contemplates and illustrative embodiments are intended to expand and become adopted into other areas of trading and order processing.

A computer system is disclosed herein that transforms data objects representing risk from non-standard granular points to standard points using a multilateral netting arrangement/optimization. In some examples, risk representation on standard points may be based on a linear attributed representation, but in other examples they may be based on a non-linear representation controlled by one or more variables. With the multilateral netting arrangement/optimization disclosed herein, the order books/systems of more than two parties/traders/users may be analyzed and processed to determine matches, while maintaining exposures as measured on standard risk points. The operations may occur in real-time (and near real-time) generation and execution through a coordinated, nearly-simultaneous execution of the order transactions that the system generates for the multiple parties (e.g., multilateral) involved in multiple levels/degrees of deep optimization. And the resulting trades from the computer system may consist of spot or forward starting swaps starting on a tenor and maturing on either non-standard or standard points.

In some embodiments, trades may be priced within a certain deviation of a pre-defined pricing curve and trades may be priced variably to maximize non-standard risk reduction while PnL tolerances are respected. In addition, in some illustrative embodiments, a computer system may keep specified ranges of points (i.e., standard and non-standard) largely unchanged to maintain balanced positions on parts of the curve.

In yet some embodiments, the computer system may be restricted to a subset of available forward starting trades all starting on the same tenor while reducing non-standard risk and managing impact on the start tenor. In some illustrative embodiments, the computer system may add risk to standard points only when there is a need to offset attributed risk due to trades added on non-standard points.

### BRIEF DESCRIPTION OF DRAWINGS

The following appendices are being included with this application filing and are also incorporated by reference herein:

FIGS. 1, 2, 3, 4, 5, 6A, 6B, 6C, 6D, and 6E correspond to Appendix A from U.S. Provisional Patent Application No. 63/383,758, which was previously incorporated by reference herein.

FIGS. 7A, 7A, 8A, and 8B correspond to Appendix B from U.S. Provisional Patent Application No. 63/383,758, which was previously incorporated by reference herein

FIGS. 9A, 9B, and 10 correspond to Appendix C from U.S. Provisional Patent Application No. 63/383,758, which was previously incorporated by reference herein.

### DETAILED DESCRIPTION

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

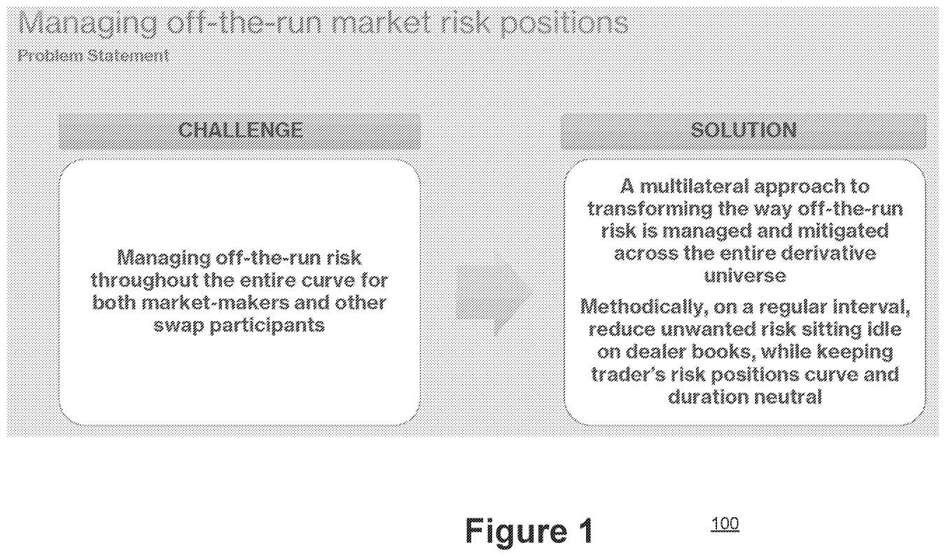

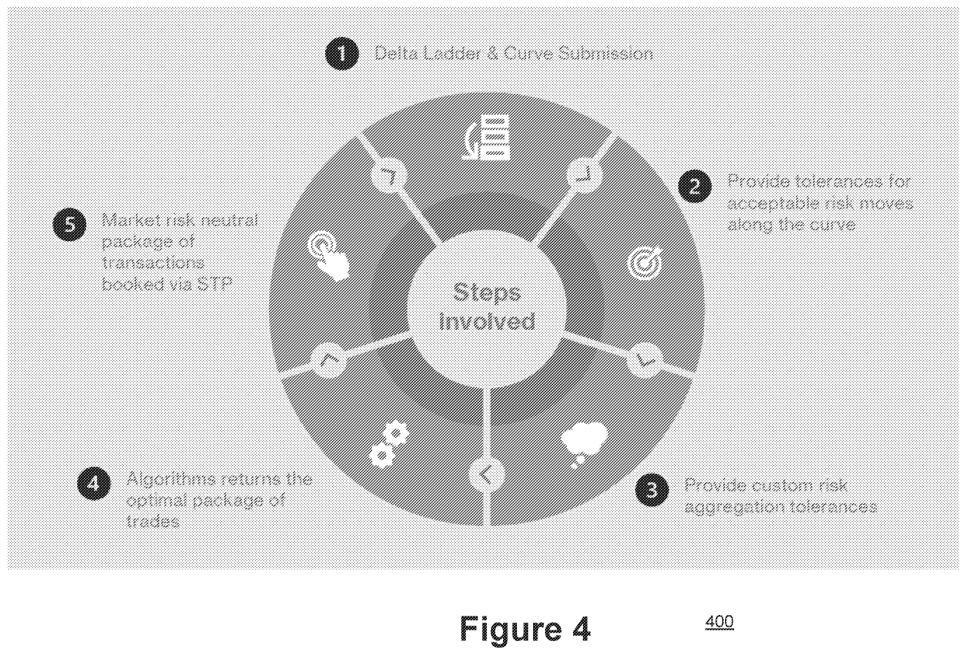

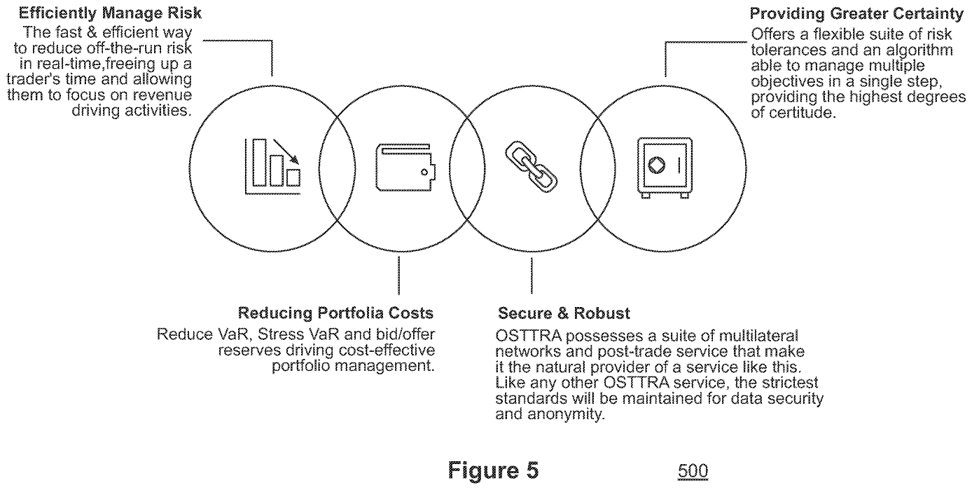

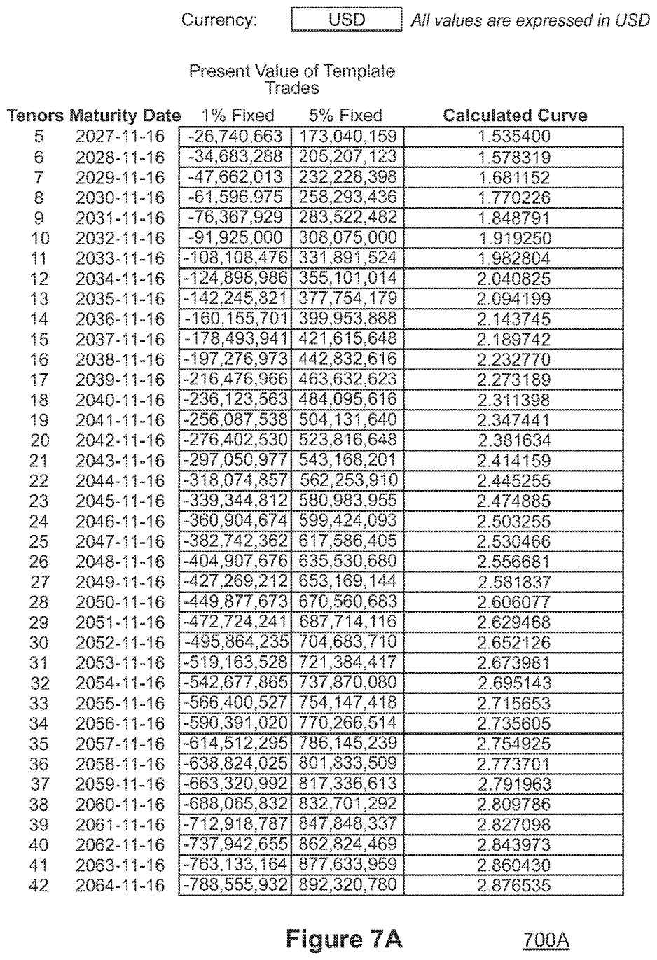

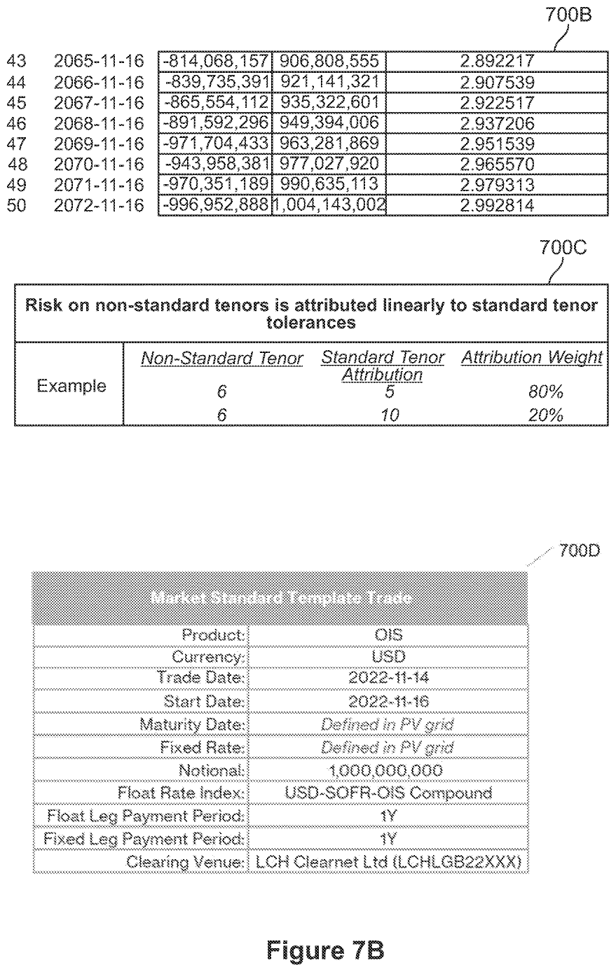

The following publicly available materials are incorporated by reference herein, specifically U.S. Pat. No. 10,803,456 (Thornberg et al.), which granted Oct. 13, 2020, and has overlapping inventorship with this application, is herein incorporated by reference in its entirety. For example, FIGS. 1 and 4 (and their accompanying detailed descriptions) in U.S. Pat. No. 10,803,456 describe a computing environment in which the features disclosed herein also may operate. This disclosure contemplates and operates on similar systems as the exchange computer system (ref. 100), trade engine (ref. 138), and user devices (ref. 120) described in U.S. Pat. No. 10,803,456, understanding that with over-the-counter (OTC) instruments such as forward contracts are not typically exchange traded, but an appropriate computer system (ref. 100) may nonetheless assist in trading, processing, clearing, and other OTC functions. Moreover, FIGS. 7-9 from U.S. Pat. No. 10,803,456 depict the generation of data objects and netting groups that may be used by the methods and systems disclosed herein.

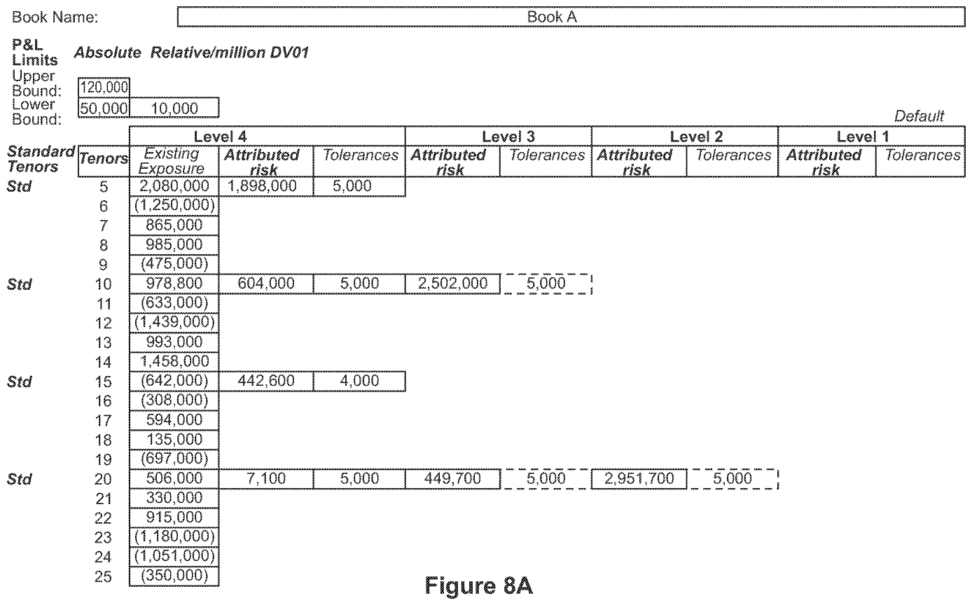

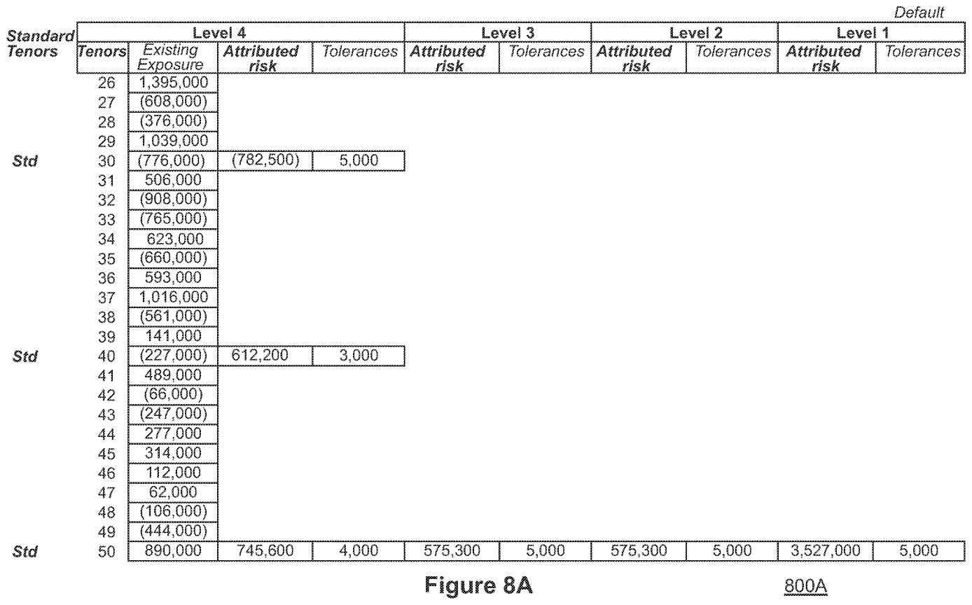

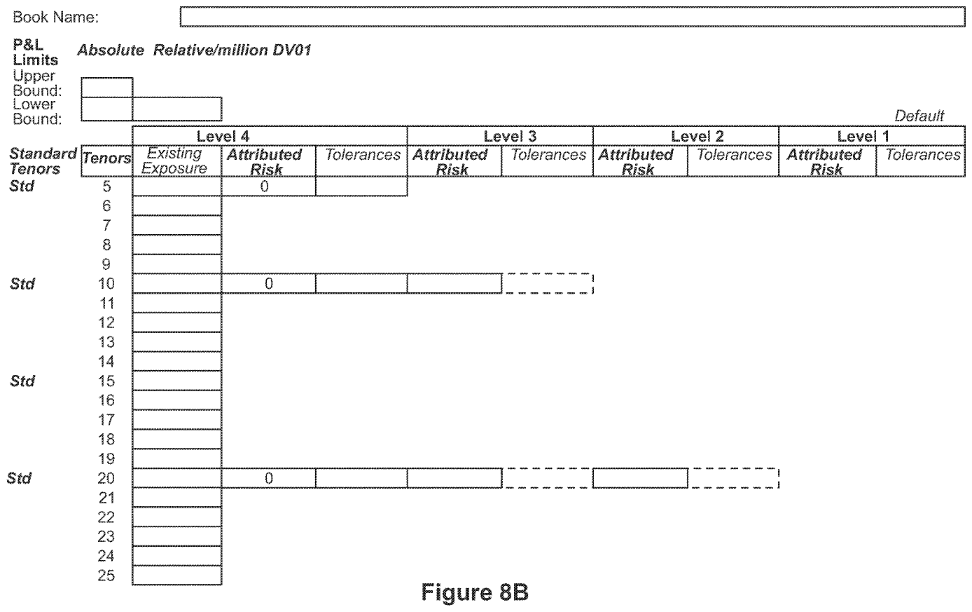

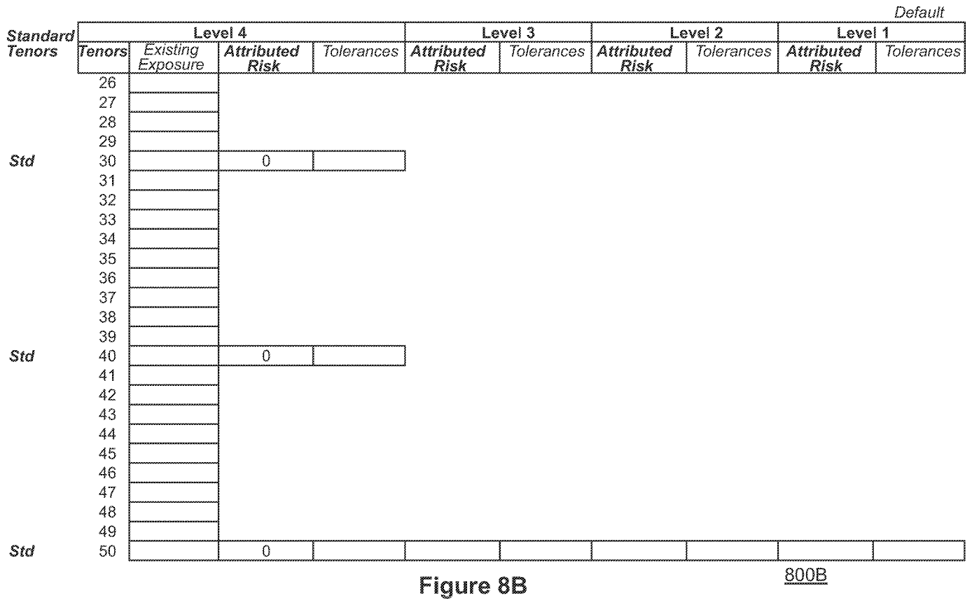

Several illustrative features of the disclosed systems include but are not limited to:
Multilateral optimization (FIG. 1, reference 100)
   In contrast, unilateral optimization examples are coupon blending, or risk-free netting.
   With a multilateral netting arrangement/optimization, which is disclosed herein, the order books/systems of more than two parties/traders/users are analyzed and processed to determine matches. The matching results in fewer/smaller non-standard tenor positions being held by the parties, thus fewer illiquid positions. (FIGS. 4 and 50 references 400 and 500).
   In some examples, the multilateral aspect includes a pooling and/or communicative coupling of multiple traders/users' books to identify opportunities for the optimization disclosed herein. In some examples, this may include generating a matrix of the tenor combinations available to each party in the multilateral interaction.
Real-time generation and execution
   Alternative to real-time, this disclosure also intends that in some examples the generation and execution may be in near real-time, such as within a few seconds or several minutes depending on the liquidity and volatility of the trading environment at a particular time and not necessarily in real-time.
   The real-time (or near real-time) execution is significant because of the need for a coordinated, nearly-simultaneous execution of the order transactions that the system generates for the multiple parties (e.g., multilateral) involved in multiple levels/degrees of deep optimization. The prior art practice involved traders/users manually making calculations on a per tenor (or bucket) basis which was suboptimal and had several drawbacks. With the disclosed system and methods herein, the process is optimized with multilateral interactions and matching of order books for both standard and non-standard tenors.
Template trades
   Appendix B (e.g., FIG. 7B, reference 700D) illustrates an example of a market standard template trade. The product illustrated is an Overnight index swap (OIS), which is an interest rate swap agreement where a fixed rate is swapped against a predetermined published index of a daily overnight reference rate (e.g., SONIA (GBP) or ESTR (EUR)) for an agreed period. However, the disclosed system is not limited to OIS and may be applied to any contract/instrument that would be contemplated by a person having ordinary skill in the art.
   Appendix B (e.g., FIGS. 7A and 7B, references 700A, 700B, and 700C) illustrates spot trades with present values (PVs). The system generates a matrix (or other structure) for each party/trader/user for a first tenor to a plurality of future tenors. For example, the matrix may start a 5-year tenor and end at a 6-year tenor, 8-year tenor, and so on. Then the same may be done with a new starting tenor, again in combination with all (or several, in some embodiments) future tenors. By combining spot trades with present value, the above-mentioned entries in the matrix will have consistent present values in relation to the spot trades. Although tenors are shown ranging from 5 to 50 (FIGS. 8A and 8B, references 800A and 800B), the system is not so limited. Rather, a 1-year tenor may be included in Appendix B. Moreover, other tenors may be included in Appendix B.
   The aforementioned matrices are then matched up by the system, in a multilateral optimization, to other parties/users/traders in the ecosystem.

Some technological advantages/benefits of some features of the disclosed systems
Reduces number of data objects in the data store that represents the positions held by a trader/user/party
   As a result, there are fewer data objects created/waiting in the queue
   This also allows traders/users to accomplish their objective with less trades and objects/execution time
Calculating delta (and other values) on the current trading book would consume less computational power because there would be fewer data objects in the data store.
Used network bandwidth when communicating portfolios to 3^{rd}-party services, such as multilateral portfolio compression, is reduced with fewer data objects.
The present values of created data objects need to be precise, which is achieved by constructing the above-mentioned matrix, but marked risk values attributed to created data objects do not. The system can thus calculate market risk on behalf of traders/users/parties and simplify the risk structure by assuming that data objects only have market risk on their start points and end points.
While market risk on non-standard tenors is reduced/optimized, the system will constrain the risk change on standard tenors to near-zero. A risk movement on a non-standard tenor will have an impact to constraints for bracketing standard tenors, assuming linear, or other, impact distribution using the years of the non-standard and standard tenors.

Some illustrative examples of optimization of market risk are disclosed herein.

Overview of several illustrative embodiments:
A computer system transforms data objects representing risk from non-standard granular points to standard points, using a linear attributed risk representation on standard points.
   In some examples the linear attributed risk representation may be based on a representation other than simply linear. For example, a representation based on a non-linear representation controlled by one or more variables.
The computer system keeps exposures as measured on standard risk points largely unchanged.
The computer system where the resulting trades may consist of spot or forward starting swaps starting on a tenor and maturing on either non-standard or standard points.
The computer system where negative P&L are constrained as a function of delta reduction or on an absolute value. A configuration, in some examples, where negative P&L is not allowed is also contemplated in this disclosure.

Some examples of submission:
Spot present values (PVs) for all standard and non-standard tenors at 1% and 5% (or other percentage) fixed coupons
Risk Targets (non-standard points) & Tolerances (standard points):
   Targets are values that will be optimized
   Tolerances are values that will be applied as a constraint
   Firms can designate their own interpretation of standard and non-standard tenors, but some tenors will be fixed as standard
   Aggregated risk across standard points may be constrained by each participant with two additional levels of customisation, and one overall level
Lower & upper P&L limits per million of risk or absolute values

Additional notes and examples:
In some examples involving particular offerings, trade deltas may be represented on the start and end dates of the trade, and any residual risk during the life of the interest rate swap may be deemed as noise. Of course a person of skill in the art after review of the entirety disclosed herein would appreciate that the aforementioned statement might not apply to all potential products/asset classes contemplated by the disclosed system and method. Although some examples disclosed herein mentioned the interest rate derivative market and utilize forward-starting swaps, the contemplated disclosure is not so limited. A person of skill in the art after review of the entirety disclosed herein would expand the novel features disclosed herein to other offerings.
The risk impact of trades introduced will be represented onto the standard points.
In some examples, trades will be priced at each participant's par rate, derived from their submitted PV's, within an allowed deviation.

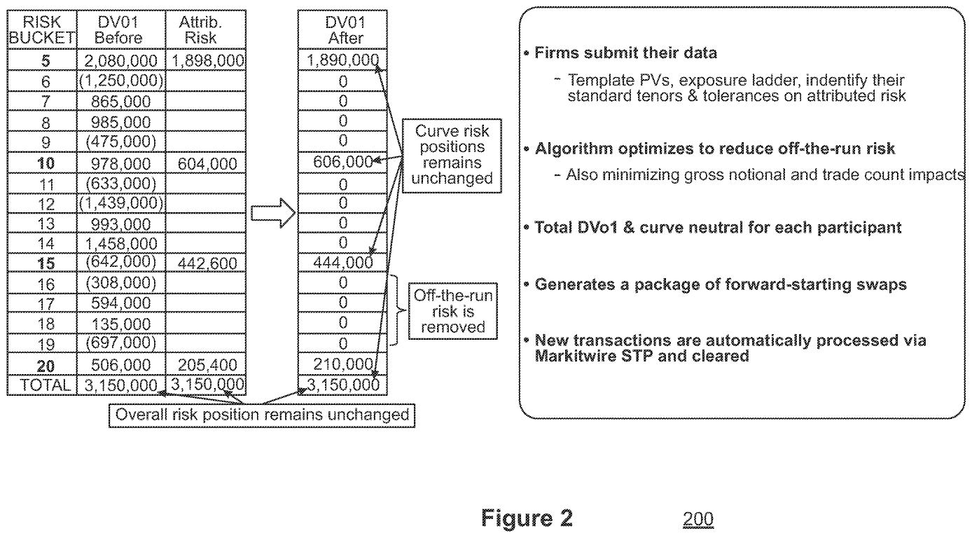

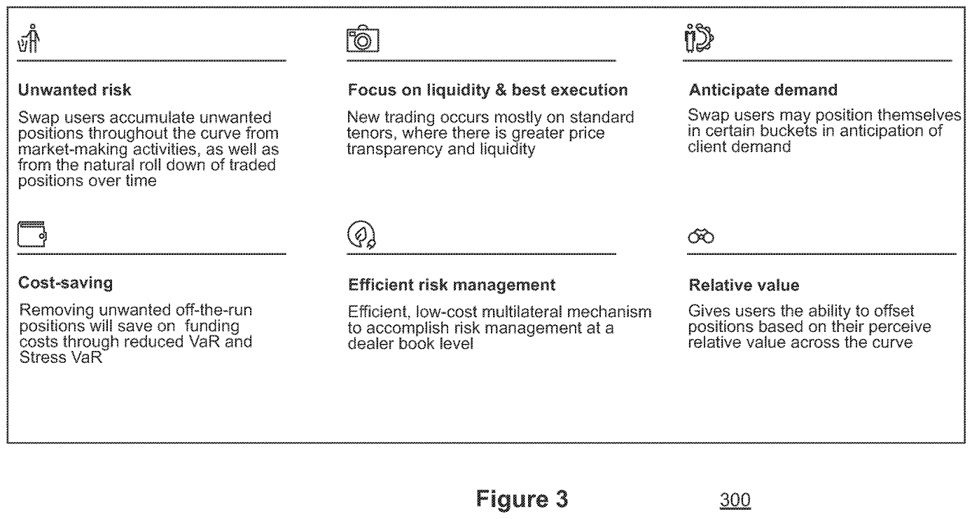

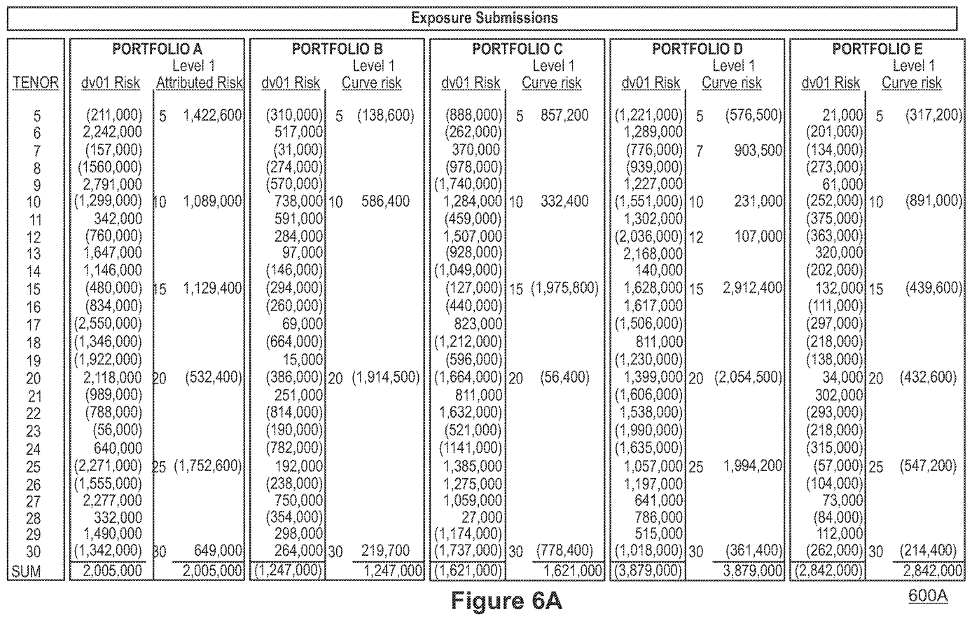

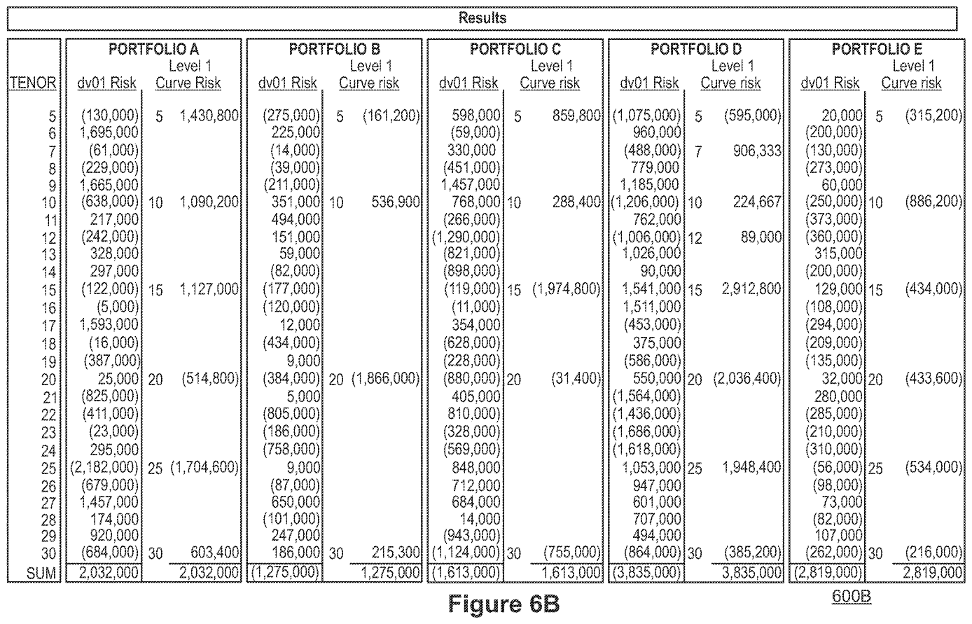

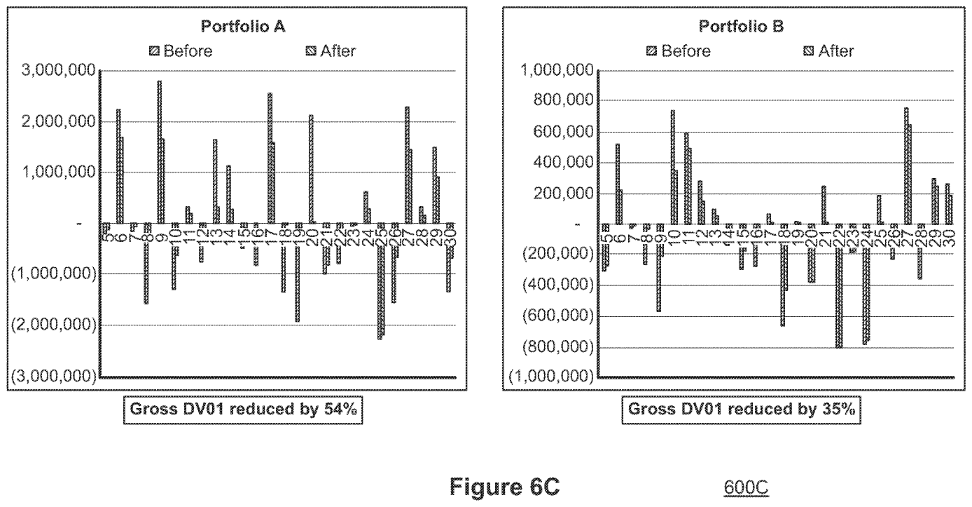

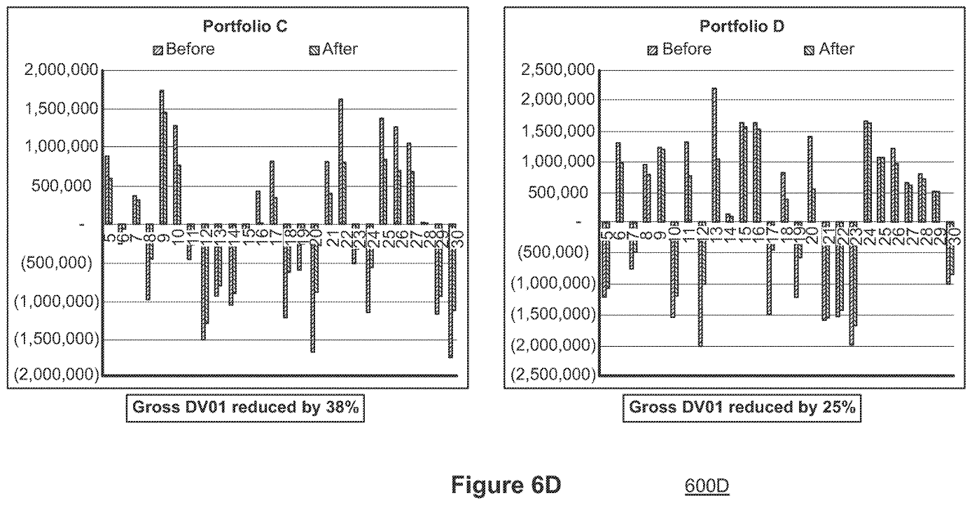

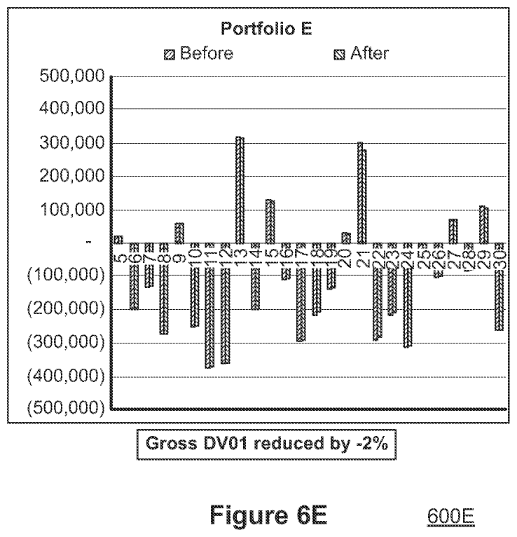

Illustrative examples of submission to the disclosed system are disclosed herein. Appendix A illustrates (FIG. 3, reference 300) one example of a user case for the novel, technological features disclosed herein. In one example, a party/trader/user submit their data (e.g., template PVs, exposure ladder, identify their standard tenors, tolerances on attributed risk, and other information, as illustrated in Appendix B) to the system for processing. The submission sheet (illustrated in Appendix B) is submitted by each trader/party/user (and in some instance might be auto-generated) and processed/stored centrally. The system (e.g., engine/algorithm) executes on this result. For example, the system performs a method/algorithm (FIG. 2, reference 200) that optimizes to reduce off-the-run risk. The system may also minimize gross notional and/or trade count impacts. The method/algorithm (FIGS. 6A-6E, References 600A, 600B, 600C, 600D, 600E) operates in a multilateral environment to consider each participant (e.g., client/party/trader/user's books) so as to generate a package of spot or forward-starting swaps, in one example. The optimization algorithm helps select between those that are linked up to ultimately identify those to trade/execute. The new transactions are automatically processed and cleared by a central counterparty (CCP) where applicable.

Although the term swap and forward contract/instrument are used separately in this disclosure, the terms are interchangeable notwithstanding that a forward contact typically has only a single payment at maturity while a swap might involve a series of payments in the future.

At least one benefit of the disclosed system and method over the prior art is that prior art systems resulted in the sum of the risk from multiple trades being net zero, but the process they performed were computationally expensive, inefficient, and the trading system ended up with more data objects (or trades) in its database. At least one technological benefit of the disclosed system and method is the multilateral arrangement reduces the number of total data objects across the multiple parties.

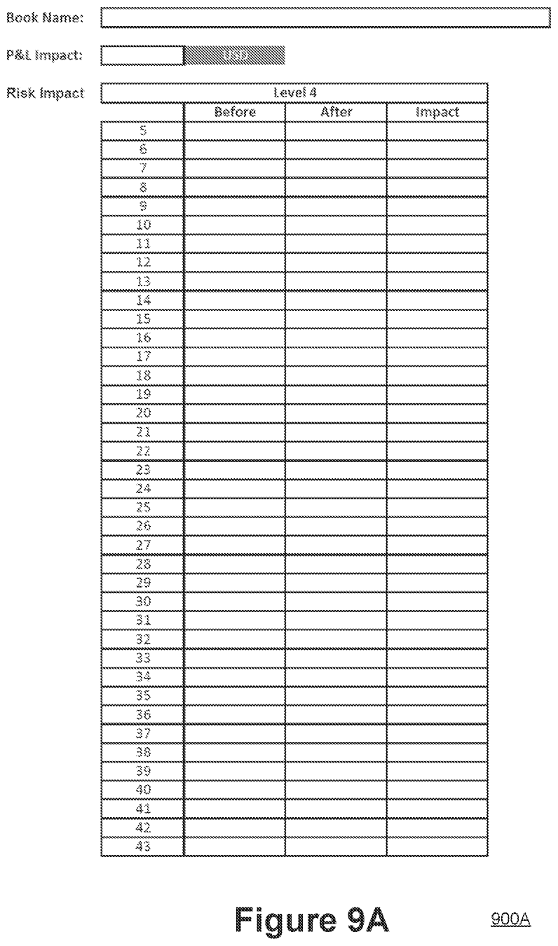

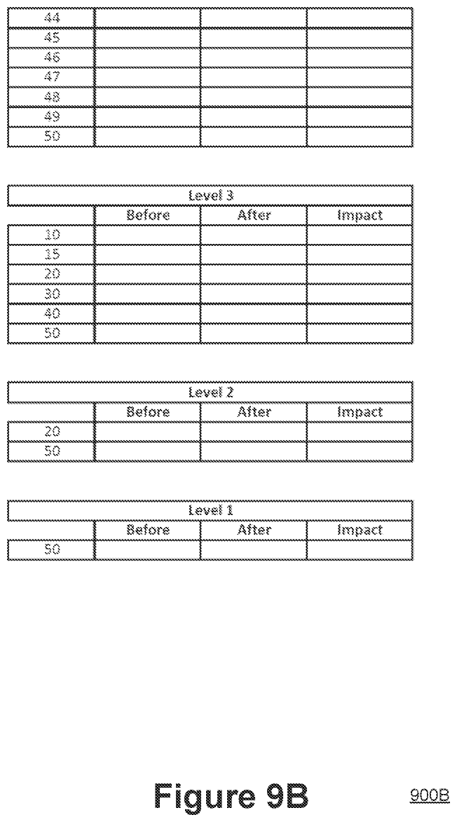

Illustrative examples of resulting output of the disclosed system are disclosed herein. One resulting output of the system is depicted in Appendix C (e.g., FIGS. 9A and 9B, references 900A and 900B), which shows a summary of the risk impacts. The result would be identified by a user/trader's unique name and would provide the P&L impact in monetary amount and the comparative before-and-after risk impact at each of Level 4, 3, 2, and 1.

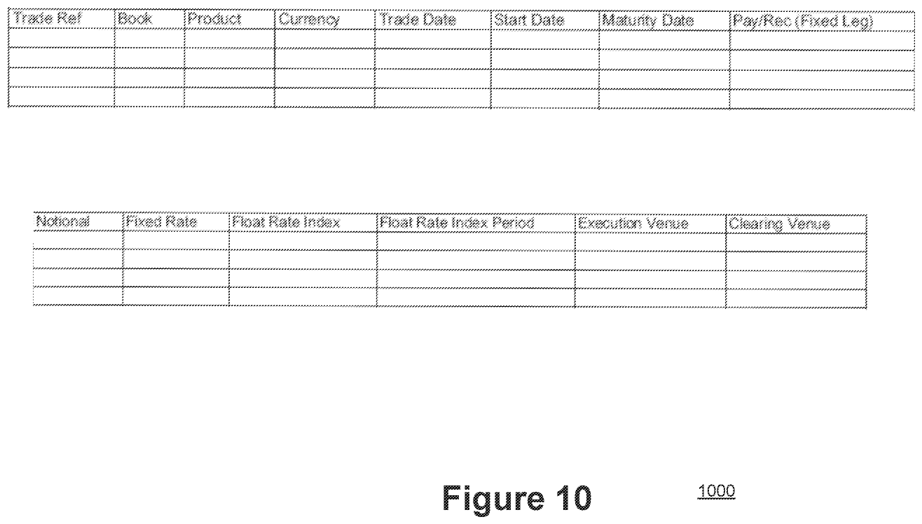

Moreover, the resulting output of the system also includes a human-readable report (as shown in Appendix C (e. g, FIG. 10, reference 1000)) of the order transactions, showing the attributes of each such as, but not limited to: Trade Ref, Book, Product, Currency, Trade Date, Start Date, Maturity Date, Pay/Rec (Fixed Leg), Notional, Fixed Rate, Float Rate Index, Float Rate Index Period, Execution Venue, Clearing Venue, etc. Other attributes, including more or less than the aforementioned listed, may be included in the human-readable report.

In addition to the aforementioned human-readable format, the transactions may be translated into FPML (or other format) to populate the transactions that are generated and for submission to an appropriate computer system for trading, processing, clearing, and/or other functions. For example, the FPML may represent multiple swap transactions that should be nearly simultaneously executed across multiple counterparties to achieve the multilateral netting arrangement/optimization disclosed herein. The FPML data may be sent in near real-time via straight-through processing (STP) onto the relevant platforms for execution and/or clearing.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention. Similarly, this disclosure contemplates that the methods and systems disclosed herein may be applied to other areas than finance. For instance, a person having ordinary skill in the art after review of the entirety disclosed herein will recognize that the methods and systems disclosed herein are applicable to logistics related areas, among others. In such a setting, the added transactions could be deliveries between different warehouses where the objective is to reduce surplus/deficits in smaller warehouses, these would correspond to non-standard points. Central warehouses may correspond to standard points where surplus/deficits are not a concern. Attribution could be defined based on the distance between warehouses indicating the potential to shift from one warehouse to another. Constraints based on costs related to delivering and attributed storage for central warehouses may be applied as well.

Moreover, although some of the apparatuses and/or systems in the disclosure may be labeled in upper case, they are not intended to describe a single apparatus or system. And the upper-case use is interchangeable with a lower-case use that fits the functional, technical, and operational requirements of the recited feature as described in this disclosure.

Finally, this disclosure contemplates and discloses a non-transitory computer-readable storage medium having computer-executable program instructions stored thereon that when executed by a processor, cause the processor to perform one or more of the method steps described herein. Moreover, this disclosure contemplates and discloses an apparatus comprising: a processor, and a tangible memory having stored therein computer executable instructions, that when executed by the processor, cause the apparatus to perform one or more of the method steps described herein.

1. A computer-implemented method comprising:
analyzing, by a computing system implementing a multilateral trading platform, data objects in a plurality of order books to perform multilateral netting optimization to transform the data objects from first data objects representing risk on non-standard points to transformed data objects representing risk on standard points; and
performing deep optimization in multiple levels to simultaneously execute order transactions that the multilateral trading platform generates for the plurality of order books;
wherein the plurality of order books comprises:
a first order book corresponding to a first user, and
a second order book corresponding to a second user different from the first user.

2-4. (canceled)

5. The computer-implemented method of claim 1, wherein the data objects are transformed from the first data objects representing risk on non-standard granular points to the transformed data objects representing risk on standard points based on a linear attributed representation.

6. The computer-implemented method of claim 1, wherein the data objects are transformed from the first data objects representing risk on non-standard granular points to the transformed data objects representing risk on standard points based on a non-linear attributed representation.

7. The computer-implemented method of claim 1, wherein the analyzing the data objects comprises determining matches between first data objects in the first order book and the second order book while maintaining exposures as measured on the standard points.

8. The computer-implemented method of claim 1, wherein the order transactions comprise spot or forward starting swaps starting on a tenor and maturing on either non-standard or standard points.

9. The computer-implemented method of claim 1, wherein the order transactions are generated by:
pricing trades within a certain deviation of a pre-defined pricing curve, and
pricing trades variably to maximize non-standard risk reduction given Profit & Loss (P&L) tolerances.

10. The method of claim 9, wherein the P&L tolerances comprise constraint of negative P&L as a function of delta reduction or to an absolute value.

11. The computer-implemented method of claim 9, wherein the trades are priced within an allowed deviation from par rates of each participant represented by the plurality of order books, wherein each par rate is based on present values (PVs) for each participant.

12. The computer-implemented method of claim 1, further comprising receiving, for each user associated with the plurality of order books, information indicating:
template present values (PVs);
an exposure ladder;
information indicating standard tenors; and
tolerances on attributed risk.

13. The computer-implemented method of claim 12, wherein the analyzing comprises applying an algorithm to the information, wherein the algorithm is an algorithm to reduce off-the-run risk.

14. The computer-implemented method of claim 13, wherein the applying the algorithm further comprises minimizing change to gross notional exposure and trade count.

15. The computer-implemented method of claim 14, wherein the applying the algorithm causes output of a package of spot or forward-starting swaps

16. The computer-implemented method of claim 1, further comprising generating the order transactions by generating, based on the multilateral netting optimization results, a package of forward-starting swaps.

17. The computer-implemented method of claim 1, the multilateral netting optimization comprises reducing exposure value associated with the non-standard points while maintaining risk exposure value associated with the standard points.

18. The computer-implemented method of claim 1, further comprising sending, by the computing system to a central counterparty (CCP) computing system, the generated order transactions for execution.

19. The method of claim 1, wherein the plurality of order books comprise more than two order books corresponding to more than two users.

20. The method of claim 1, wherein the analyzing the data objects in the plurality of order books comprises generating a matrix of tenor combinations available to each user associated with the plurality of order books.

21. One or more non-transitory computer-readable storage media having stored thereon computer-executable instructions that, when executed by one or more processors of a computing system, configure the computing system to:
analyze, by a computing system implementing a multilateral trading platform, data objects in a plurality of order books to perform multilateral netting optimization to transform the data objects from first data objects representing risk on non-standard points to transformed data objects representing risk on standard points; and
perform deep optimization in multiple levels to simultaneously execute order transactions that the multilateral trading platform generates for the plurality of order books;
wherein the plurality of order books comprises:
a first order book corresponding to a first user, and
a second order book corresponding to a second user different from the first user.

22. The one or more non-transitory computer-readable storage media of claim 21, wherein the instructions, when executed, further configure the computing system to analyze the data objects by determining matches between first data objects in the first order book and the second order book while maintaining exposures as measured on the standard points.

23. A computing system for implementing a multilateral trading platform, the computing system comprising:
a plurality of order books;
a computer processor; and
a computer memory storing instructions that, when executed by the computer processor, cause the multilateral trading platform to:
analyze, by a computing system implementing a multilateral trading platform, data objects in a plurality of order books to perform multilateral netting optimization to transform the data objects from first data objects representing risk on non-standard points to transformed data objects representing risk on standard points; and
perform deep optimization in multiple levels to simultaneously execute order transactions that the multilateral trading platform generates for the plurality of order books;
wherein the plurality of order books comprises:
a first order book corresponding to a first user, and
a second order book corresponding to a second user different from the first user.
